(19) United States
(12) Patent Application Publication
(10) Pub. No.: US 2015/0377826 A1
(43) Pub. Date: Dec. 31, 2015

(54) AGING DEVICE FOR CONSTANT-POTENTIAL ELECTROLYTIC GAS SENSOR AND AGING METHOD FOR CONSTANT-POTENTIAL ELECTROLYTIC GAS SENSOR

(71) Applicant: Kabushiki Kaisha Toshiba, Minato-ku (JP)

(72) Inventors: Shinichi SASAKI, Yokohama (JP); lkuo UEMATSU, Yokohama (JP); Naoya HAYAMIZU, Yokohama (JP)

(73) Assignee: Kabushiki Kaisha Toshiba, Minato-ku (JP)

(21) Appl. No.: 14/745,824

(22) Filed: Jun. 22, 2015

(30) Foreign Application Priority Data
Jun. 25, 2014 (JP) 2014-130345

(51) Int. Cl. G01N 27/416

(52) U.S. Cl. CPC G01N 27/4163

(57) ABSTRACT

According to one embodiment, an aging device includes an operation and measurement unit, and a control unit. The operation and measurement unit is configured to perform application of potential between at least any one of a counter electrode and a reference electrode provided in a constant-potential electrolytic gas sensor and a working electrode provided in the constant-potential electrolytic gas sensor and measurement of an electric current flowing between the working electrode and the counter electrode. The control unit is configured to calculate the potential at a start of the flow of the electric current between the working electrode and the counter electrode and control the operation and measurement unit such that potential higher than the potential at the start of the flow of the electric current is applied between at least any one of the counter electrode and the reference electrode and the working electrode.

### CROSS-REFERENCE TO RELATED APPLICATIONS

This application is based upon and claims the benefit of priority from Japanese Patent Application No. 2014-130345, filed on Jun. 25, 2014; the entire contents of which are incorporated herein by reference.

### FIELD

Embodiments described herein relate generally to an aging device for constant-potential electrolytic gas sensor and aging method for constant-potential electrolytic gas sensor.

### BACKGROUND

There is a constant-potential electrolytic gas sensor as a type of a gas sensor that detects gasses such as hydrogen sulfide, ozone, carbon monoxide, and arsine.

The constant-potential electrolytic gas sensor measures, in response to electrochemical reaction, an electrolytic current flowing between a working electrode and a counter electrode and converts a value of the electrolytic current into the concentration of gas which is a measuring object.

For example, when the constant-potential electrolytic gas sensor is used for the first time or when the constant-potential electrolytic gas sensor is not used for a long time, fluctuation of an output occurs.

Therefore, aging for applying potential between the working electrode and at least any one of the counter electrode and a reference electrode is performed until constant output sensitivity is obtained.

In such aging, there is a problem that a time required for aging varies or the time becomes longer.

### BRIEF DESCRIPTION OF THE DRAWINGS

FIG. 1 is a schematic view for illustrating an aging device 1 according to the embodiment; and

FIG. 2 is a graph for illustrating a relation between the potential applied between the reference electrode 104 and the working electrode 102 and the electric current flowing between the working electrode 102 and the counter electrode 103.

### DETAILED DESCRIPTION

In general, according to one embodiment, an aging device includes an operation and measurement unit, and a control unit. The operation and measurement unit is configured to perform application of potential between at least any one of a counter electrode and a reference electrode provided in a constant-potential electrolytic gas sensor and a working electrode provided in the constant-potential electrolytic gas sensor and measurement of an electric current flowing between the working electrode and the counter electrode. The control unit is configured to calculate the potential at a start of the flow of the electric current between the working electrode and the counter electrode and control the operation and measurement unit such that potential higher than the potential at the start of the flow of the electric current is applied between at least any one of the counter electrode and the reference electrode and the working electrode.

An embodiment is illustrated below with reference to the drawings. Note that, in the figures, the same components are denoted by the same reference numerals and signs and detailed description of the components is omitted as appropriate.

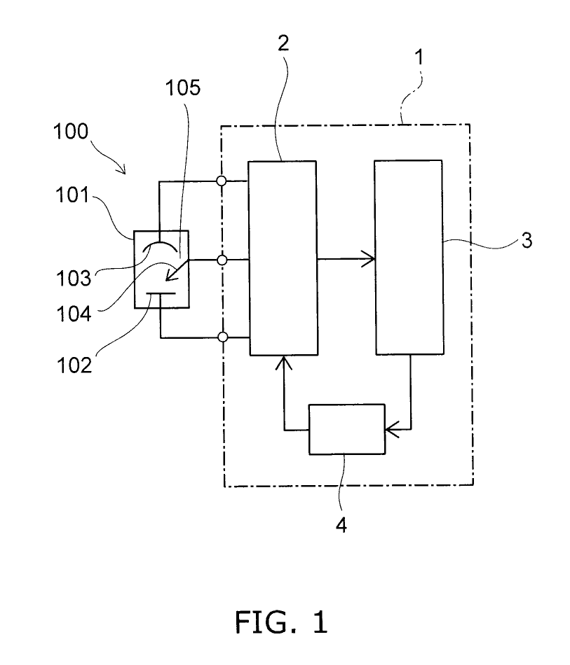

FIG. 1 is a schematic view for illustrating an aging device 1 according to the embodiment.

As shown in FIG. 1, the aging device 1 is electrically connected to a constant-potential electrolytic gas sensor 100.

First, the constant-potential electrolytic gas sensor 100 is illustrated.

The constant-potential electrolytic gas sensor 100 includes a container 101, a working electrode 102, a counter electrode 103, a reference electrode 104, and an electrolytic solution 105.

The working electrode 102, the counter electrode 103, and the reference electrode 104 are electrodes.

The container 101 has a sealing structure that is capable of retaining the electrolytic solution 105.

The working electrode 102 is provided on the inside of the container 101.

The counter electrode 103 is provided on the inside of the container 101. The counter electrode 103 is opposed to the working electrode 102.

The reference electrode 104 is provided on the inside of the container 101. The reference electrode 104 is opposed to the working electrode 102.

In this case, the reference electrode 104 may be provided between the working electrode 102 and the counter electrode 103 or may be provided side by side with the counter electrode 103.

The working electrode 102, the counter electrode 103, and the reference electrode 104 are respectively electrically connected to terminals of the aging device 1 (an operation and measurement unit 2).

The working electrode 102, the counter electrode 103, and the reference electrode 104 include, for example, substrates made of fluorocarbon resin or the like and films made of an electrode forming material (e.g., gold) suitable for oxidizing and reducing a test gas provided on the substrates.

The films made of the electrode forming material can be formed using, for example, a sputtering method.

The working electrode 102, the counter electrode 103, and the reference electrode 104 can also be formed by, for example, applying a mixture of powder made of the electrode forming material and powder made of the fluorocarbon resin or the like on the substrates and sintering the mixture.

The electrolytic solution 105 is provided among the electrodes in a state in which the electrolytic solution 105 is impregnated in a sheet made of nonwoven fabric or the like.

The electrolytic solution 105 can be, for example, a solution containing sulfuric acid.

The container 101 includes a not-shown ventilation passage for introducing the test gas into the inside of the container 101, a not-shown ventilation passage for discharging gas on the inside of the container 101 to the outside, and not-shown filters respectively provided in the ventilation passages.

Note that the filters can also be filters provided with absorbent that absorbs an interference gas that affects measurement.

The action of the constant-potential electrolytic gas sensor 100 is illustrated.

The test gas introduced into the inside of the container 101 via the ventilation passage dissolves in the electrolytic solution 105. The working electrode 102 is kept at constant potential with respect to the reference electrode 104. Therefore, the test gas is electrolyzed on the interface between the working electrode 102 and the electrolytic solution 105. A reaction current corresponding to the concentration of the test gas flows between the working electrode 102 and the counter electrode 103. A relation between the reaction current and the concentration of the test gas can be calculated by performing an experiment or the like in advance. Therefore, it is possible to calculate the concentration of the test gas by measuring the reaction current.

The constant-potential electrolytic gas sensor 100 detects the concentration of the test gas as described above.

The aging device 1 according to the embodiment is illustrated.

The aging device 1 includes the operation and measurement unit 2, a measuring unit 3, and a control unit 4.

The working electrode 102, the counter electrode 103, and the reference electrode 104 are electrically connected to the operation and measurement unit 2.

The operation and measurement unit 2 performs application of potential between at least any one of the counter electrode 103 and the reference electrode 104 and the working electrode 102 and measurement of an electric current flowing between the working electrode 102 and the counter electrode 103.

For example, the operation and measurement unit 2 controls the potential applied between the reference electrode 104 and the working electrode 102 to be constant and measures the electric current flowing between the working electrode 102 and the counter electrode 103 or controls the electric current flowing between the working electrode 102 and the counter electrode 103 to be constant and measures the potential applied between the reference electrode 104 and the working electrode 102.

The operation and measurement unit 2 can be, for example, a potentio/galvanostat.

The measuring unit 3 is electrically connected to the operation and measurement unit 2.

The measuring unit 3 measures impedance on the basis of an output from the operation and measurement unit 2.

The measuring unit 3 can be, for example, a frequency response analyzer.

The measuring unit 3 is not always necessary and can be provided according to necessity.

The control unit 4 is electrically connected to the operation and measurement unit 2 and the measuring unit 3.

The control unit 4 controls the operation and measurement unit 2 and performs aging of the constant-potential electrolytic gas sensor 100.

For example, the control unit 4 calculates potential at the start of the flow of an electric current between the working electrode 102 and the counter electrode 103 and controls the operation and measurement unit 2 such that potential higher than the calculated potential is applied between at least any one of the counter electrode 103 and the reference electrode 104 and the working electrode 102.

The aging of the constant-potential electrolytic gas sensor 100 is illustrated.

For example, when the constant-potential electrolytic gas sensor 100 is used for the first time or when the constant-potential electrolytic gas sensor 100 is not used for a long time, fluctuation of an output sometimes occurs.

Therefore, the aging for applying potential between at least any one of the counter electrode 103 and the reference electrode 104 and the working electrode 102 until constant output sensitivity is obtained is performed.

In such aging, in some case, time required for the aging fluctuates or a long time is required until the completion of the aging.

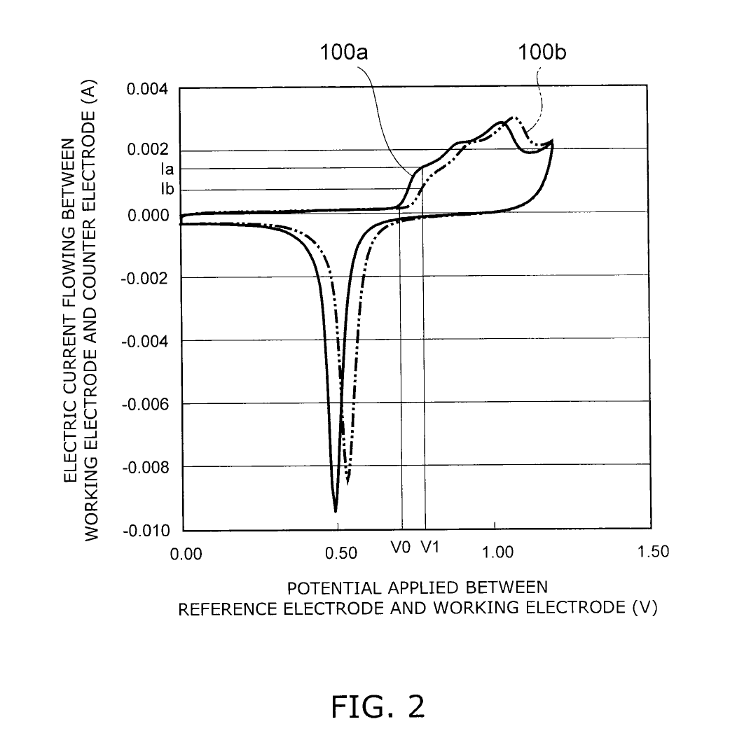

FIG. 2 is a graph for illustrating a relation between the potential applied between the reference electrode 104 and the working electrode 102 and the electric current flowing between the working electrode 102 and the counter electrode 103.

Note that, in the case of FIG. 2, the working electrode 102, the counter electrode 103, and the reference electrode 104 are made of gold and the electrolytic solution 105 contains 8.7 M (mol/L) of sulfuric acid.

When the potential applied between the reference electrode 104 and the working electrode 102 is increased, an electric current starts to flow between the working electrode 102 and the counter electrode 103.

For example, as shown in FIG. 2, when the potential applied between the reference electrode 104 and the working electrode 102 is set to V0 or higher, an electric current starts to flow between the working electrode 102 and the counter electrode 103.

When the electric current starts to flow between the working electrode 102 and the counter electrode 103, a compound is formed on the surface of the working electrode 102. For example, when the working electrode 102 is made of gold, gold hydroxide “Au(OH)n” is formed on the surface of the working electrode 102.

If the compound is formed on the surface of the working electrode 102 and a surface state becomes uniform, the fluctuation in the output is suppressed. That is, if the compound is formed on the surface of the working electrode 102 by feeding the electric current between the working electrode 102 and the counter electrode 103, the aging can be ended.

However, there is an individual difference in a way of flowing of the electric current.

For example, as shown in FIG. 2, even if the applied potential is the same V1, a current value is Ia in a constant-potential electrolytic gas sensor 100a and a current value is Ib in a constant-potential electrolytic gas sensor 100b.

Therefore, even in the same constant-potential electrolytic gas sensor, in some case, time required for the aging fluctuates or a long time is required until the completion of the aging.

As a result of the examination by the inventors, it has been found that a surface state of at least any one of the counter electrode 103 and the reference electrode 104 considerably affects the aging.

The individual difference in the way of flowing of the electric current occurs according to, for example, surface states of the counter electrode 103 and the reference electrode 104 during manufacturing of the constant-potential electrolytic gas sensor 100 and an amount of deposits (e.g., a deposit composed of components of the test gas) adhering to the surfaces of the counter electrode 103 and the reference electrode 104 when the constant-potential electrolytic gas sensor 100 is used. Therefore, time required for the aging fluctuates or a long time is required until the completion of the aging.

In this case, if the surface states of the counter electrode 103 and the reference electrode 104 are set in a predetermined range or the deposits adhering to the surfaces of the counter electrode 103 and the reference electrode 104 are removed, it is possible to attain suppression of the fluctuation in the time required for the aging and a reduction in the time of the aging.

However, this is likely to increase necessary labor and time to the contrary.

According to the knowledge obtained by the inventors, if potential at the start of the flow of the electric current between the working electrode 102 and the counter electrode 103 is detected and potential higher than the potential by 0.1 V or more is applied between at least any one of the counter electrode 103 and the reference electrode 104 and the working electrode 102, it is possible to attain the suppression of the fluctuation in the time required for the aging and the reduction in the time of the aging.

The action of the aging apparatus 1 is illustrated.

First, the control unit 4 controls the operation and measurement unit 2 to change potential applied between at least any one of the counter electrode 103 and the reference electrode 104 and the working electrode 102 and measures an electric current flowing between the working electrode 102 and the counter electrode 103.

In this case, the measuring unit 3 measures the impedance between the working electrode 102 and the counter electrode 103 on the basis of an output from the operation and measurement unit 2.

Subsequently, the control unit 4 calculates, on the basis of the output from the operation and measurement unit 2, potential at the start of the flow of the electric current between the working electrode 102 and the counter electrode 103.

Subsequently, the control unit 4 controls the operation and measurement unit 2 to apply potential higher than the calculated potential between at least any one of the counter electrode 103 and the reference electrode 104 and the working electrode 102.

In this case, the control unit 4 controls the operation and measurement unit 2 such that potential higher than the calculated potential by 0.1 V or more is applied between any one of the counter electrode 103 and the reference electrode 104 and the working electrode 102.

Subsequently, the control unit 4 determines an end period of the aging on the basis of an output from the operation and measurement unit 2.

The control unit 4 determines the end of the aging on the basis of, for example, a value of the electric current flowing between the working electrode 102 and the counter electrode 103.

In this case, for example, when a value of the electric current flowing between the working electrode 102 and the counter electrode 103 exceeds a predetermined value or the value of the electric current flowing between the working electrode 102 and the counter electrode 103 stabilizes, the control unit 4 can determine that the aging ends.

Note that a reference value of an electric current can be calculated by performing an experiment or the like in advance.

For example, the control unit 4 can also end the aging when a predetermined time elapses after potential higher than the calculated potential is applied between at least any one of the counter electrode 103 and the reference electrode 104 and the working electrode 102.

Note that the predetermined time can be calculated by performing an experiment or the like in advance.

As described above, an aging method of the constant-potential electrolytic gas sensor according to the embodiment can include processes described below.

A process for changing the potential applied between at least any one of the counter electrode 103 and the reference electrode 104 and the working electrode 102 and measuring the electric current flowing between the working electrode 102 and the counter electrode 103. A process for calculating potential at the start of the flow of the electric current between the working electrode 102 and the counter electrode 103.

A process for applying potential higher than the calculated potential between at least any one of the counter electrode 103 and the reference electrode 104 and the working electrode 102.

In this case, in the process for applying the potential higher than the calculated potential between at least any one of the counter electrode 103 and the reference electrode 104 and the working electrode 102, potential higher than the potential at the start of the flow of the electric current by 0.1 V or more can be applied between at least any one of the counter electrode 103 and the reference electrode 104 and the working electrode 102.

The aging method can further include a process for determining an end of the aging on the basis of a value of the electric current flowing between the working electrode 102 and the counter electrode 103 after the potential higher than the calculated potential is applied between at least any one of the counter electrode 103 and the reference electrode 104 and the working electrode 102.

In this case, for example, when a value of the electric current flowing between the working electrode 102 and the counter electrode 103 exceeds a predetermined value or when the value of the electric current flowing between the working electrode 102 and the counter electrode 103 stabilizes, it is possible to determine that the aging ends.

It is also possible to end the aging when a predetermined time elapses after the potential higher than the calculated potential is applied between at least any one of the counter electrode 103 and the reference electrode 104 and the working electrode 102.

Note that contents in the processes can be the same as the contents described above. Therefore, detailed description of the contents of the processes is omitted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. An aging device comprising:
an operation and measurement unit configured to perform application of potential between at least any one of a counter electrode and a reference electrode provided in a constant-potential electrolytic gas sensor and a working electrode provided in the constant-potential electrolytic gas sensor and measurement of an electric current flowing between the working electrode and the counter electrode; and
a control unit configured to calculate the potential at a start of the flow of the electric current between the working electrode and the counter electrode and control the operation and measurement unit such that potential higher than the potential at the start of the flow of the electric current is applied between at least any one of the counter electrode and the reference electrode and the working electrode.

2. The device according to claim 1, wherein the control unit controls the operation and measurement unit such that potential higher than the potential at the start of the flow of the electric current by 0.1 V or more is applied between at least any one of the counter electrode and the reference electrode and the working electrode.

3. The device according to claim 1, wherein the control unit determines an end of aging on the basis of a value of the electric current flowing between the working electrode and the counter electrode.

4. The device according to claim 3, wherein, when the value of the electric current flowing between the working electrode and the counter electrode exceeds a predetermined value, the control unit determines that the aging ends.

5. The device according to claim 3, wherein, when the value of the electric current flowing between the working electrode and the counter electrode stabilizes, the control unit determines that the aging ends.

6. The device according to claim 1, wherein, when a predetermined time elapses after the potential higher than the potential at the start of the flow of the electric current is applied, the control unit determines that the aging ends.

7. The device according to claim 1, wherein the operation and measurement unit controls the potential applied between the reference electrode and the working electrode to be constant and measures the electric current flowing between the working electrode and the counter electrode.

8. The device according to claim 1, wherein the operation and measurement unit is a potentio/galvanostat.

9. The device according to claim 1, further comprising a measuring unit configured to measure impedance on the basis of an output from the operation and measurement unit.

10. The device according to claim 9, wherein the measuring unit is a frequency response analyzer.

11. An aging method comprising:
changing potential applied between at least any one of a counter electrode and a reference electrode provided in a constant-potential electrolytic gas sensor and a working electrode provided in the constant-potential electrolytic gas sensor and measuring an electric current flowing between the working electrode and the counter electrode;
calculating the potential at a start of the flow of the electric current between the working electrode and the counter electrode; and
applying potential higher than the potential at the start of the flow of the electric current between at least any one of the counter electrode and the reference electrode and the working electrode.

12. The method according to claim 11, wherein, in the applying the potential higher than the potential at the start of the flow of the electric current between at least any one of the counter electrode and the reference electrode and the working electrode, potential higher than the potential at the start of the flow of the electric current by 0.1 V or more is applied between at least any one of the counter electrode and the reference electrode and the working electrode.

13. The method according to claim 11, further comprising determining, after applying the high potential between at least any one of the counter electrode and the reference electrode and the working electrode, an end of aging on the basis of a value of the electric current flowing between the working electrode and the counter electrode.

14. The method according to claim 13, wherein, in the determining the end of the aging, when the value of the electric current flowing between the working electrode and the counter electrode exceeds a predetermined value, it is determined that the aging ends.

15. The method according to claim 13, wherein, in the determining the end of the aging, when the value of the electric current flowing between the working electrode and the counter electrode stabilizes, it is determined that the aging ends.

16. The method according to claim 11, wherein, in the determining the end of the aging, the aging is ended when a predetermined time elapses after the high potential is applied between at least any one of the counter electrode and the reference electrode and the working electrode.

17. The method according to claim 11, wherein, in the measuring the electric current flowing between the working electrode and the counter electrode, the potential between the reference electrode and the working electrode is controlled to be constant and the electric current flowing between the working electrode and the counter electrode is measured.

18. The method according to claim 11, wherein, in the measuring the electric current flowing between the working electrode and the counter electrode, control of the potential and the measurement of the electric current are performed using a potentio/galvanostat.

19. The method according to claim 11, further comprising measuring impedance on the basis of the electric current flowing between the working electrode and the counter electrode.

20. The method according to claim 19, wherein, in the measuring the impedance, the impedance is measured using a frequency response analyzer.
